(19) United States
(12) Patent Application Publication
(10) Pub. No.: US 2006/0118487 A1
(43) Pub. Date: Jun. 8, 2006

(54) Membrane filtration process

(76) Inventors: Nicholas William Harcsar Adams, Hamilton (CA); Manwinder Singh, Burlington (CA); Fraser Charles Kent, Milton (CA); Pierre Lucien Cote, Dundas (CA)

Correspondence Address: BERESKIN AND PARR, 40 KING STREET WEST, BOX 401, TORONTO, ON, M5H 3Y2, CA

(21) Appl. No.: 11/267,130

(22) Filed: Nov. 7, 2005

Related U.S. Application Data
(60) Provisional application No. 60/633,432, filed on Dec. 7, 2004.

(51) Int. Cl. B01D 65/02

(52) U.S. Cl. 210/636; 210/650

(57) ABSTRACT

Various filtration processes using low amounts of aeration are disclosed. One process comprises a cycle of permeating and then backwashing, aerating, partially draining the tank and refilling the tank. Another process comprises steps of (a) permeating and withdrawing retentate; (b) after (a), backwashing; and (c) during (a), providing gentle aeration. Another process comprises a cycle of (a) permeating; (b) after (a), backpulsing; (c) during (b) and extending into a portion of (a), aerating; and, (d) during a portion of (a), withdrawing retentate

This is an application claiming the benefit under 35 USC 119(e) of U.S. Provisional Patent Application Ser. No. 60/633,432 filed Dec. 7, 2004. U.S. Ser. No. 60/633,432 is incorporated herein, in its entirety, by this reference to it.

### FIELD OF THE INVENTION

This invention relates to membrane separation devices and processes as in, for example, water filtration using membranes.

### BACKGROUND OF THE INVENTION

Typically a batch filtration process has a repeated cycle of concentration, or permeation, and deconcentration steps. During the concentration step, permeate is withdrawn from a fresh batch of feed water initially having a low concentration of solids. As the permeate is withdrawn, fresh water is introduced to replace the water withdrawn as permeate. During this step, which may last from 10 minutes to 4 hours, solids are rejected by the membranes and do not flow out of the tank with the permeate. As a result, the concentration of solids in the tank increases, for example to between 2 and 100, more typically 5 to 50, times the initial concentration. The process then proceeds to the deconcentration step. In the deconcentration step, which is typically between 1/50 and ⅕ the duration of the concentration step, a large quantity of solids are rapidly removed from the tank to return the solids concentration back to the initial concentration. This may be done by completely draining the tank and refilling it with new feed water. To help move solids away from the membranes themselves, air scouring and backwashing may be used before or during the deconcentration step.

An alternate process is a feed and bleed process. In a feed and bleed process, feed water flows generally continuously into a tank. Permeate is withdrawn generally continuously, but may be stopped from time to time for example for backwashing. Retentate is generally continuously bled out of the tank. The average flow rate of retentate may be 1-20% of the feed flow rate, the remainder of the feed flow being removed as permeate. Aeration may be provided continuously or intermittently during permeation.

### SUMMARY OF THE INVENTION

It is an object of the invention to provide an apparatus and method for treating water. It is another object of the invention to provide a membrane separation device and process. The following summary is intended to introduce the reader to the invention and not to define the invention, which may reside in a sub-combination of the following features or in a combination involving features described in other parts of this document, for example the claims.

The invention provides various filtration processes. The filtration processes may be used, for example, in new plants or as a retrofit for existing plants such as feed and bleed plants with continuous aeration. After retrofitting an existing feed and bleed plant with continuous aeration, the invention may reduce the amount of aeration required at an acceptable cost to implement the changes.

In one aspect, the invention provides a cyclical process in which, after a dead end permeation period, the membranes are backpulsed and aerated. After the backpulsing, a portion of the tank, for example about 10-25% of the tank, is drained. Aeration may continue during this partial drain. After the partial drain, the tank is refilled and permeation begins in the next cycle.

In another aspect, the invention provides a process having a generally continuous reject bleed. Permeation is also generally continuous, but is stopped periodically, for example for backwashing. Aeration is provided during this backwash and intermittently between backwashes.

In another aspect, the invention provides a cyclical process in which permeation is generally continuous but for periodic backwashing. Aeration is provided during the backwash but continues for a period of time after the backwash. Retentate flow occurs during the backwash and continues beyond the backwash and aeration but for less than the entire cycle duration.

### BRIEF DESCRIPTION OF THE DRAWINGS

Embodiments of the invention will now be described with reference to the following figures.

FIG. 1 is a schematic diagram of a filtration apparatus.

FIGS. 2, 3, and 4 are representations of various membrane cassettes.

FIGS. 5, 6 and 7 are diagrams of processes according the embodiments of the invention.

### DETAILED DESCRIPTION OF EMBODIMENTS

The following description of a filtration apparatus applies generally to the embodiments which are described further below unless inconsistent with the description of any particular embodiment.

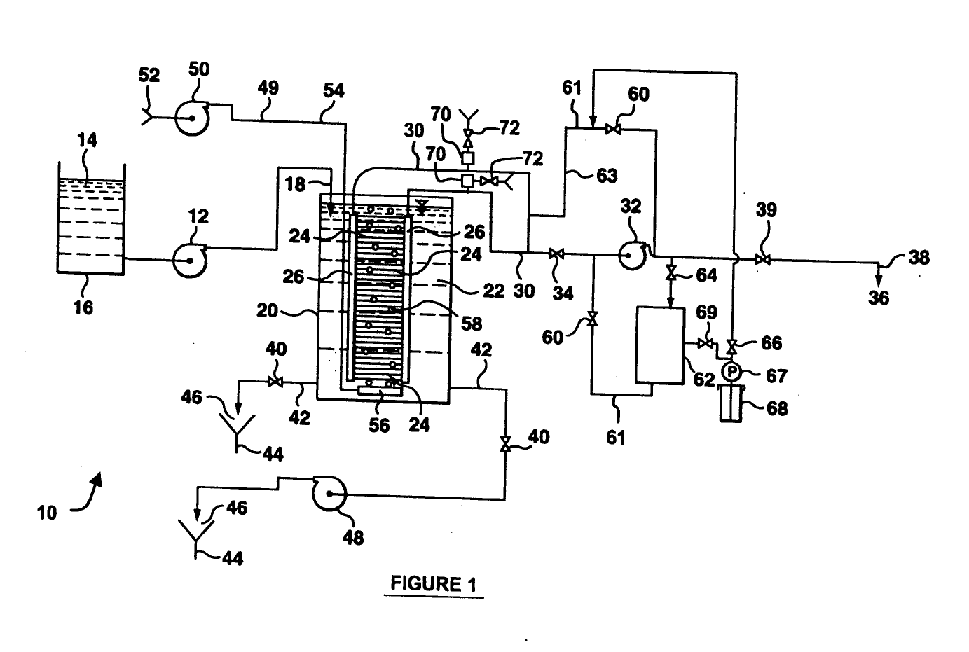

Referring now to FIGS. 1 to 4, a reactor 10 is shown for treating a liquid feed having solids to produce a filtered permeate with a reduced concentration of solids and a retentate with an increased concentration of solids. Such a reactor 10 has many potential applications, but will be described below as used for creating potable water from a supply of water such as a lake, well, or reservoir. Such a water supply typically contains colloids, suspended solids, bacteria and other particles or substances which must be filtered out and will be collectively referred to as solids whether solid or not.

The first reactor 10 includes a feed pump 12 which pumps feed water 14 to be treated from a water supply 16 through an inlet 18 to a tank 20 where it becomes tank water 22. Alternatively, a gravity feed may be used with feed pump 12 replaced by a feed valve. Each membrane 24 has a permeate side 25 which does not contact the tank water 22 and a retentate side which does contact the tank water 22. The membranes 24 may be hollow fibre membranes 24 for which the outer surface of the membranes 24 is the retentate side and the lumens of the membranes 24 are the permeate side 25.

Each membrane 24 is attached to one or more headers 26 such that the membranes 24 are surrounded by potting resin to produce a watertight connection between the outside of the membranes 24 and the headers 26 while keeping the permeate side 25 of the membranes 24 in fluid communication with a permeate channel in at least one header 26. Membranes 24 and headers 26 together form an element 8. The permeate channels of the headers 26 are connected to a permeate collector 30 and a permeate pump 32 through a permeate valve 34. Air entrained in the flow of permeate through the permeate collectors 30 becomes trapped in air collectors 70, typically located at at least a local high point in a permeate collector 30. The air collectors 70 are periodically emptied of air through air collector valves 72 which may, for example, be opened to vent air to the atmosphere when the membranes 24 are backwashed. Filtered permeate 36 is produced for use at a permeate outlet 38 through an outlet valve 39. Periodically, a storage tank valve 64 is opened to admit permeate 36 to a storage tank 62. The filtered permeate 36 may require post treatment before being used as drinking water, but should have acceptable levels of colloids and other suspended solids.

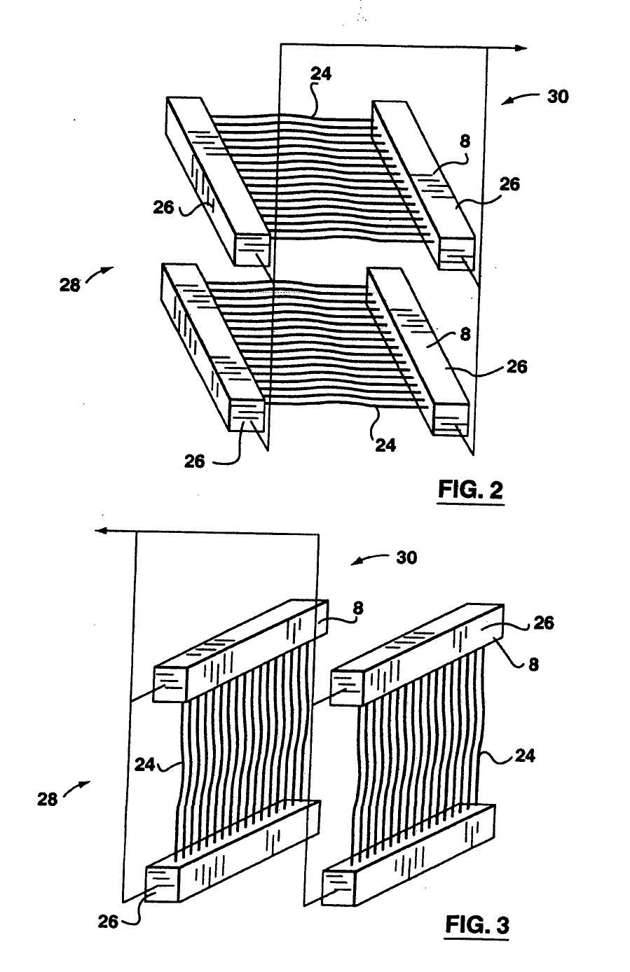

In a large reactor 10, a plurality of elements 8 are assembled together into cassettes 28. Examples of such cassettes 28 are shown in FIGS. 2,3 and 4 although a cassette 28 would typically have more elements 8 than shown. Each element 8 of the type illustrated may have a bunch between 2 cm and 10 cm wide of hollow fibre membranes 24. Other sorts of elements 8 and cassettes 28 may also be used. The membranes 24 may have an average pore size in the microfiltration or ultrafiltration range, for example between 0.003 microns and 10 microns or between 0.02 microns and 1 micron.

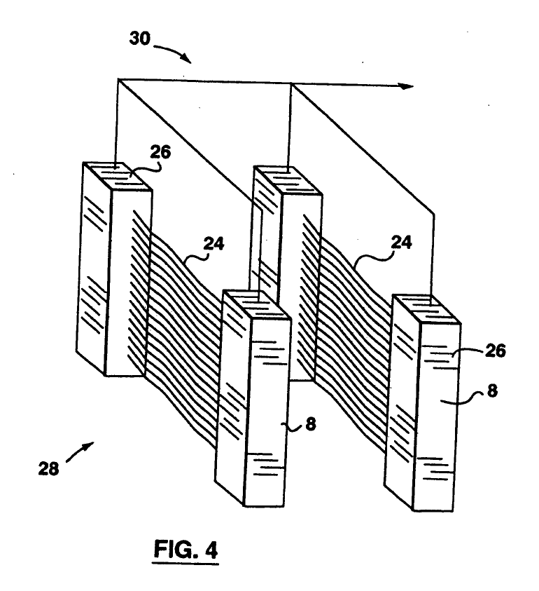

Referring to FIG. 2, for example, a plurality of elements 8 are connected to a common permeate collector 30. Depending on the length of the membranes 24 and the depth of the tank 20, multiple cassettes 28 as shown in FIG. 2 may also be stacked one above the other. Referring to FIGS. 3 and 4, the elements 8 are shown in alternate orientations. In FIG. 3, the membranes 24 are oriented in a horizontal plane and the permeate collector 30 is attached to a plurality of elements 8 stacked one above the other. In FIG. 4, the membranes 24 are oriented horizontally in a vertical plane. Depending on the depth of the headers 26 in FIG. 4, the permeate collector 30 may also be attached to a plurality of these cassettes 28 stacked one above the other. The representations of the cassettes 28 in FIGS. 2, 3, and 4 have been simplified for clarity, actual cassettes 28 typically having elements 8 much closer together and many more elements 8.

Cassettes 28 can be created with elements 8 of different shapes, for example cylindrical, and with bunches of looped fibres attached to a single header or fibers held in a header at one end and loose at the other. Similar modules or cassettes 28 can also be created with tubular membranes in place of the hollow fibre membranes 24. For flat sheet membranes, pairs of membranes are typically attached to headers or casings that create an enclosed surface between the membranes and allow appropriate piping to be connected to the interior of the enclosed surface. Several of these units can be attached together to form a cassette of flat sheet membranes. Commercially available cassettes 28 include those made by ZENON Environmental Inc. and sold under the ZEE WEED trademark, for example, as ZEE WEED 500 or ZEE WEED 1000 products.

Referring again to FIG. 1, tank water 22 which does not flow out of the tank 20 through the permeate outlet 38 flows out of the tank 20 at some time through a drain valve 40 and a retentate outlet 42 to a drain 44 as retentate 46 with the assistance of a retentate pump 48 if necessary.

To provide air scouring, alternately called aeration, an air supply pump 50 blows ambient air, nitrogen or other suitable gases from an air intake 52 through air distribution pipes 54 to aerator 56 or sparger which disperses scouring bubbles 58. The bubbles 58 rise through the membrane module 28 and discourage solids from depositing on the membranes 24. In addition, where the design of the reactor 10 permits it, the bubbles 58 also create an air lift effect which in turn circulates the local tank water 22.

To provide backwashing, permeate valve 34 and outlet valve 39 are closed and backwash valves 60 are opened. Permeate pump 32 is operated to push filtered permeate 36 from retentate tank 62 through backwash pipes 61 and then in a reverse direction through permeate collectors 30 and the walls of the membranes 24 thus pushing away solids. At the end of the backwash, backwash valves 60 are closed, permeate valve 34 and outlet valve 39 are re-opened and pressure tank valve 64 opened from time to time to re-fill retentate tank 62.

To provide chemical cleaning from time to time, a cleaning chemical such as sodium hypochlorite, sodium hydroxide or citric acid is provided in a chemical tank 68. Permeate valve 34, outlet valve 39 and backwash valves 60 are all closed while a chemical backwash valve 66 is opened. A chemical pump 67 is operated to push the cleaning chemical through a chemical backwash pipe 69 and then in a reverse direction through permeate collectors 30 and the walls of the membranes 24. At the end of the chemical cleaning, chemical pump 67 is turned off and chemical pump 66 is closed. Preferably, the chemical cleaning is followed by a permeate backwash to clear the permeate collectors 30 and membranes 24 of cleaning chemical before permeation resumes.

To fill the tank 20, a feed pump 12 pumps feed water 14 from the water supply 16 through the inlet 18 to the tank 20 where it becomes tank water 22. The tank 20 is filled when the level of the tank water 22 completely covers the membranes 24 in the tank 20 but the tank 20 may also have tank water 22 above this level.

To permeate, the permeate valve 34 and an outlet valve 39 are opened and the permeate pump 32 is turned on. A negative pressure is created on the permeate side 25 of the membranes 24 relative to the tank water 22 surrounding the membranes 24. The resulting transmembrane pressure, typically between 1 kPa and 150 kPa, draws tank water 22 (then referred to as permeate 36) through the membranes 24 while the membranes 24 reject solids which remain in the tank water 22. Thus, filtered permeate 36 is produced for use at the permeate outlet 38. Periodically, a storage tank valve 64 is opened to admit permeate 36 to a storage tank 62 for use in backwashing. As filtered permeate 36 is removed from the tank, the feed pump 12 is operated to keep the tank water 22 at a level which covers the membranes 24 accounting for retentate removal during permeation, if any, or removal of foam or other substances, if any.

To backwash the membranes, alternately called backpulsing or backflushing, with permeation stopped, backwash valves 60 and storage tank valve 64 are opened. Permeate pump 32 is turned on to push filtered permeate 36 from storage tank 62 through a backwash pipe 63 to the headers 26 and through the walls of the membranes 24 in a reverse direction thus pushing away some of the solids attached to the membranes 24. The volume of water pumped through the walls of a set of the membranes 24 in the backwash may be between 10% and 40%, more often between 20% and 30%, of the volume of the tank 20 holding the membranes 24. At the end of the backwash, backwash valves 60 are closed. As an alternative to using the permeate pump 32 to drive the backwash, a separate pump can also be provided in the backwash line 63 which may then by-pass the permeate pump 32. By either means, the backwashing may continue for between 15 seconds and one minute. When the backwash is over, permeate pump 32 is then turned off and backwash valves 60 closed. The flux during backwashing may be 1 to 3 times the permeate flux and may be provided continuously, intermittently or in pulses.

To provide scouring air, alternately called aeration, the air supply pump 50 is turned on and blows air, nitrogen or other appropriate gas from the air intake 52 through air distribution pipes 54 to the aerators 56 located below, between or integral with the membrane elements 8 or cassettes 28 and disperses air bubbles 58 into the tank water 22 which flow upwards past the membranes 24.

The amount of air scouring to provide is dependant on numerous factors but is preferably related to the superficial velocity of air flow through the aerators 56. The superficial velocity of air flow is defined as the rate of air flow to the aerators 56 at standard conditions (1 atmosphere and 25 degrees Celsius) divided by the cross sectional area effectively scoured by the aerators 56. Scouring air may be provided by operating the air supply pump 50 to produce air corresponding to a superficial velocity of air flow between 0.005 m/s and 0.15 m/s. At the end of an air scouring step, the air supply pump 50 is turned off. Although air scouring is most effective while the membranes 24 are completely immersed in tank water 22, it is still useful while a portion of the membranes 24 are exposed to air. Air scouring may be more effective when combined with backwashing.

Air scouring may also be provided at times to disperse the solids in the tank water 22 near the membranes 24. This air scouring prevents the tank water 22 adjacent the membranes 24 from becoming overly rich in solids as permeate is withdrawn through the membranes 24. For this air scouring, air may be provided continuously at a superficial velocity of air flow between 0.0005 m/s and 0.015 m/s or intermittently at a superficial velocity of air flow between 0.005 m/s and 0.15 m/s.

To drain the tank 20, also called rejection, reject removal or bleed, the drain valves 40 are opened to allow tank water 22, then containing an increased concentration of solids and called retentate 46, to flow from the tank 20 through a retentate outlet 42 to a drain 44. The retentate pump 48 may be turned on to drain the tank more quickly, but in many installations the tank will empty rapidly enough by gravity alone, particularly where a reject bleed is desired during permeation. It may take between two and ten minutes to drain the tank 20 completely from full and less time to partially drain the tank 20.

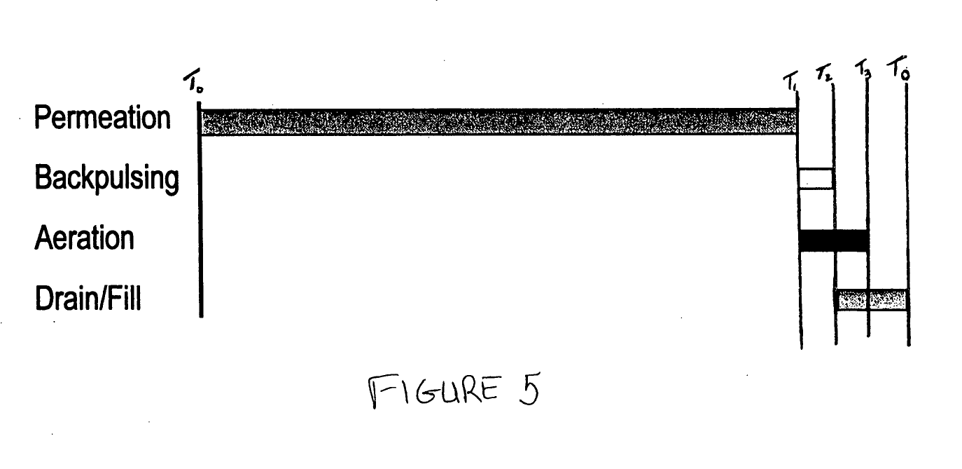

FIG. 5 shows a first process. Permeation begins at T₀ and continues to T₁. The time between T₀ and T₁, which may be 15 to 40 minutes for example, may be dead end permeation, that is permeation without withdrawal of retentate. At T₁, permeation stops and backpulsing and aeration begin. Backpulsing and aeration continue for 15 seconds to 5 minutes or 30 seconds to 90 seconds until T₂. At T₂, backwashing stops and a partial drain or refill of the tank begins. During the drain/refill, a portion, for example 10-25%, of the normal volume of tank water 22, for example the average volume of water present during permeation, is drained from the tank and then replaced with fresh feed water. Parts of the membranes may be exposed during these steps. These steps may take for example from 30 seconds to 5 minutes and end with T₀ at the start of the next cycle. Aeration may continue until a time T₃ occurring during the drain/refill step. Compared to a continuously aerated feed and bleed process, the process of FIG. 5 may allow a 90-95% reduction in the amount of aeration required while still handling medium to high solid loadings, for example a TSS of 1000 mg/L. Although the plant must be modified or built to provide for rapid partial drains and refill, the process requires less modification or drain and feed capacity than a batch process having a complete tank drain and refill steps.

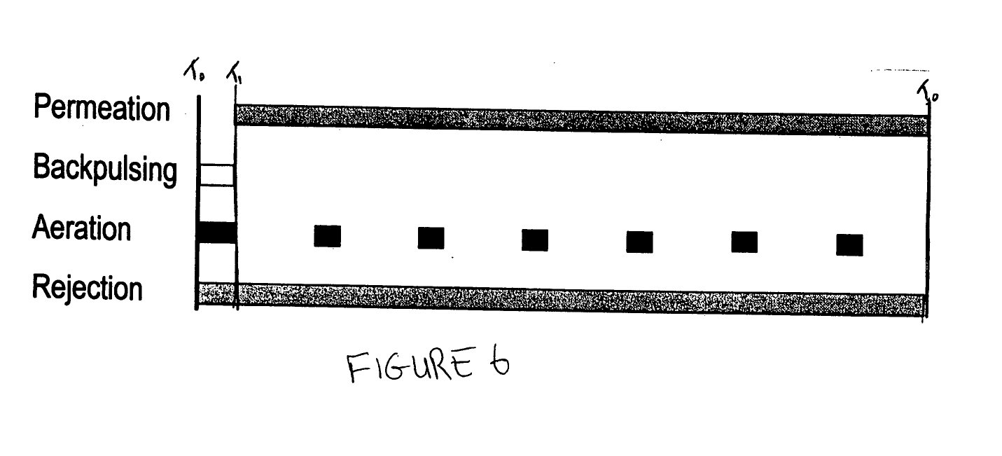

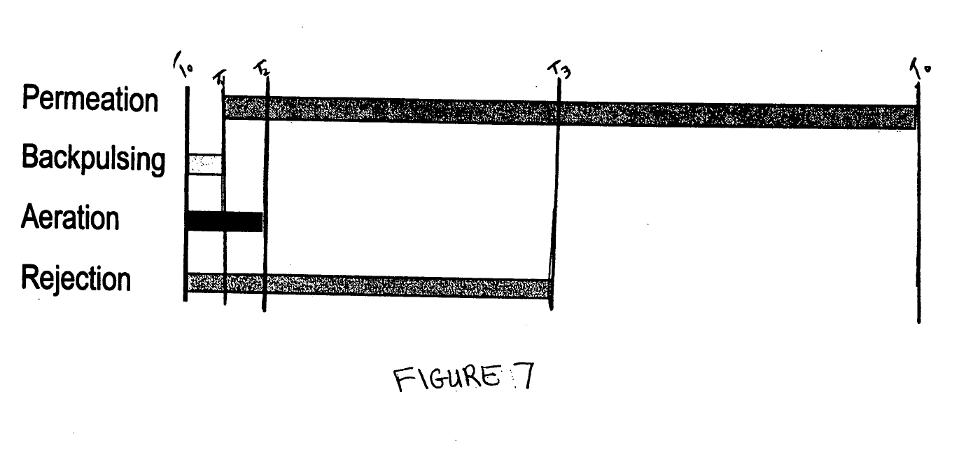

FIG. 6 shows another process. At T₀, the membranes are backwashed and aerated until T₁. The time between T₀ and T₁ may be about, for example 10 seconds to 60 seconds or about 15 seconds. The backpulse and aeration need not occur exactly at the same time, or for the same duration of time, as shown. At T₁, permeation and aeration for resuspension begin. As shown, the aeration may be intermittent, for example 5-20 seconds or about 10 seconds every 1 to 4 minutes or about 2 minutes at the regular aeration rate. Alternately, continuous aeration at a reduced rate may be provided. A generally continuous bleed or reject is provided generally throughout the cycle. The cycles may last, for example for between 10 and 20 minutes or about 15 minutes.

Compared to a continuously aerated feed and bleed process, aeration may be reduced by about 80-85%. Only modifications to the aeration system are required. However, the process may result in reduced fluxes or occasional sludging of the membranes in medium or high solids concentration plants, although it may be adequate for low to medium solids concentration plants.

FIG. 7 shows another process. Backpulsing, aeration and rejection begin at T₀. Backpulsing stops, for example after 10-30 seconds or, about 15 seconds, at T₁ and permeation begins. Aeration continues until T₂, which may be, for example about 60-120 seconds or about 90 seconds after T₀. Reject removal continues until T₃. After T₃, reject removal stops while permeation continues to T₀ of the next cycle. T₃ is chosen to include a period after T₂ when the TSS concentration in the reject remains elevated due to the backpulsing and aeration, which may be, for example about 5 to 10 minutes or about 7.5 minutes after T₀. The rate of reject removal may be chosen, or T₃ extended, to achieve a desired volumetric removal of retentate. Alternately, if reject removal until T₃ does not remove enough volume of tank water, rejection may begin again prior to T₀. The total cycle time may be, for example about 10-20 minutes or about 15 minutes and reject may be withdrawn for, for example about ⅔ or ½ or less of the duration of the cycle.

Compared to a continuously aerated feed and bleed process, this method may reduce aeration by 80% or more. The plant or design must be modified to accept increased reject flow rates, for example 150% or twice or more of the design flow of a continuous bleed plant, but those modifications are less than for a batch process with full tank drainings. The process can handle medium to high solids loadings.

In the paragraphs above, comparisons with a continuously aerated feed and bleed process assumed that the continuously aerated feed and bleed process uses aeration in a 10 seconds on 10 seconds off cycle throughout permeation. A low solids level has an after flocculation feed solids level of less than 5 mg/L. A high solids level has an after flocculation feed solids level of over 25 mg/L. A medium solids level is between these two.

The preceding description was of exemplary embodiments only and does not limit the scope of the invention, which may be practiced with various modifications.

We claim:

1. A filtration process comprising the steps of:
a) permeating; and,
b) after step (a), backwashing, aerating, partially draining the tank and refilling the tank,
wherein steps a) and b) are performed in repeated cycles.

2. The process of claim 1 wherein the step of permeating is dead end.

3. The process of claim 2 wherein 10-25% of the tank design volume is drained in step b).

4. A filtration process comprising the steps of:
a) permeating and withdrawing retentate;
b) after a) backwashing; and,
c) during a), providing aeration intermittently.

5. The process of claim 4 wherein step c) comprises aeration for between 5 and 30 seconds every 1 to 5 minutes.

6. A filtration process comprising the steps of:
a) permeating;
b) after a), backpulsing;
c) during b) and extending into a portion of a), aerating; and,
d) during a portion of a), withdrawing retentate,
wherein the steps above are performed in repeated cycles.

7. The process of claim 6 wherein part of step d) is performed during 25-60% of step a).

8. The process of claim 7 wherein part of step d) is performed during step b).
